(19) United States
(12) Patent Application Publication
(10) Pub. No.: US 2015/0379215 A1
(43) Pub. Date: Dec. 31, 2015

(54) Automated Waiting Room Queue and Management Service

(71) Applicant: Practice Fusion, Inc., San Francisco, CA (US)

(72) Inventors: Kurt WEBER, Seattle, WA (US); Francois L. Cantonnet, Seattle, WA (US)

(21) Appl. No.: 14/317,668

(22) Filed: Jun. 27, 2014

(51) Int. Cl. G06F 19/00

(52) U.S. Cl. CPC G06F 19/327; G06F 19/322

(57) ABSTRACT

In an embodiment, a computer-implemented method reschedules medical appointments. The method comprises storing an appointment schedule information associated with a medical provider and receiving an indication that an appointment spot has become available. A patient is selected to fill the available spot based on an analysis of the appointment schedule information and patient data or doctor data. The method then transmits a notification of the available spot to the patient.

### BACKGROUND

1. Field

This application is generally related to the scheduling and management of appointments.

2. Background

### Electronic Health Records

Medical records related to a patient's health information are essential to the practice of medical care. Traditionally, medical records were paper-based documents. The emergence of electronic medical records (EMR), which are digital version of the paper chart that contains all of a patient's medical history from one medical practice, offers medical professionals and patients with new functionalities and efficiencies that paper-based medical records cannot provide. An electronic health record (EHR), also known as an electronic medical record (EMR), is a collection of electronically stored information about an individual patient's medical history. EHRs may contain a broad range of data, including demographics, medical history, medication history, allergies, immunization records, laboratory test results, radiology images, vital signs, personal statistics like age and weight, and billing information. Many commercial EHR systems combine data from a number of health care services and providers, such as clinical care facilities, laboratories, radiology centers, and pharmacies.

EHRs are a drastic improvement over paper-based medical records. Paper-based medical records require a large amount of physical storage space. Paper records are often stored in different locations, and different medical professionals may each have different and incomplete records about the same patient. Obtaining paper records from multiple locations for review by a health care provider can be time consuming, complicated, and sometimes impossible. In contrast, EHR data is stored in digital format, and thus are more secure and can be accessed from anywhere. EHR systems significantly simplify the reviewing process for health care providers. Because records in EHRs can be linked together, EHRs vastly improve the accessibility of health records and the coordination of medical care.

EHRs also decrease the risk of misreading errors by health care professionals. Poor legibility is often associated with handwritten, paper medical records, which can lead to medical errors. EHRs, on the other hand, are inherently legible given that they are typically stored in typeface. In addition, electronic medical records enhance the standardization of forms, terminology and abbreviations, and data input, which help ensure reliability of medical records, and standardization of codesets and storage of EHR data means that data from different technical information systems can be displayed in a single, unified record. Further, EHRs can be transferred electronically, thus reducing delays and errors in recording prescriptions or communicating laboratory test results.

The benefits of digitizing health records are substantial. Health care providers with EHR systems have reported better outcomes, fewer complications, lower costs, and fewer malpractice claim payments. But despite EHRs' potential in drastically improving the quality of medical care, only a low percentage of health care providers use EHR systems. While the advantages of EHRs are significant, they also carry concerns, including high costs, lost productivity during EHR implementation or computer downtime, and lack of EHR usability.

The Health Insurance Portability and Accountability Act (HIPAA), enacted in the U.S. in 1996, and as amended, established rules for use and access of protected health information (PHI). HIPAA provides restrictions on disclosure of and access to protected health information to and by third parties. HIPAA applies to information in electronic medical records, such as health information doctors and nurses input, documented conversations between a doctor and a patient, and information use to process or facilitate medical billing claims and documents. The HIPAA Security Rule, effective on Apr. 20, 2005 for most covered entities, adds additional constraints to electronic data security and the storage and transmission of PHI.

The high cost of EHRs also significantly hinders EHR adoption. A large number of physicians without EHRs have referred to initial capital costs as a barrier to adopting EHR systems. Cost concerns are even more severe in smaller health care settings, because current EHR systems are more likely to provide cost savings for large integrated institutions than for small physician offices. During the EHR technology's setup and implementation process, productivity loss can further offset efficiency gains. The need to increase the size of information technology staff to maintain the system adds even more costs to EHR usages.

Usability is another major factor that holds back adoption of EHRs. It is particularly challenging to develop user-friendly EHR systems. There is a wide range of data that needs to be integrated and connected. Complex information and analysis needs vary from setting to setting, among health care provider groups, and from function to function within a health care provider group. To some providers, using electronic medical records can be tedious and time consuming, and the complexity of some EHR systems renders the EHR usage less helpful. Some doctors and nurses also complain about the difficulty and the length of time to enter patients' health information into the system.

Under-utilization of EHR systems, despite incentives and mandates from the government and the tremendous potential of EHRs in revolutionizing the health care system, calls for better EHR systems that are secure, cost-effective, efficient, and user-friendly.

Comprehensive EHR systems can provide capabilities far beyond simply storing patients' medical records. Because EHR systems offer health care providers and their workforce members the ability to securely store and utilize structured health information, EHR systems can have a profound impact on the quality of the health care system. In Framework for Strategic Action on Health Information Technology, published on Jul. 21, 2004, the Department of Health & Human Services (HHS) outlined many purposes for EHR services. The outlined purposes include, among other things, improving health care outcomes and reducing costs, reducing recordkeeping and duplication burdens, improving resource utilization, care coordination, active quality and health status monitoring, reducing treatment variability, and promoting patients' engagement in and ownership over their own health care.

Recent legislation has set goals and committed significant resources for health information technology (IT). One of the many initiatives of the American Recovery and Reinvestment Act of 2009 (ARRA) was “to increase economic efficiency by spurring technological advances in science and health.” The Health Information Technology for Economic and Clinical Health (HITECH) Act, passed as a part of ARRA, allocated billions of dollars for health care providers to adopt and meaningfully use EHRs in their practices. HITECH also mandates the Office of the National Coordinator for Health Information Technology (ONC) to define certification criteria for “Certified EHR Technology.”

EHR systems satisfying “Certified EHR Technology” criteria are capable of performing a wide range of functions, including: entry and storage, transmission and receipt of care summaries, clinical decision support, patient lists and education resources, generation of public health submission data, and patient engagement tools. Entry and storage is related to the ability to enter, access and modify patient demographic information, vital signs, smoking status, medications, clinical and radiology laboratory orders and results. Transmission and receipt of care summaries involve the ability to receive, incorporate, display and transmit transition of care/referral summaries. Clinical decision support features configurable clinical decision support tools, including evidence-based support interventions, linked referential clinical decision support, and drug-drug and drug-allergy interaction checks. Patient lists and education resources include the ability to create patient lists based on problems, medications, medication allergies, demographics and laboratory test result values, and the ability to identify patient-specific education resources based on such data elements. Generating public health submission data allows users to create electronic immunization and syndromic surveillance data files that can be submitted to public health agencies. Patient engagement tools allow medical professionals to grant patients with an online means to view, download and transmit their health information to a third party, provide patients with clinical summaries after office visits, and facilitate secure-doctor patient messaging.

### Appointment Scheduling

Despite the advances in maintaining patient health records and other practice information electronically, many medical practices still follow traditional approaches to scheduling appointments. Existing calendar or EHR services may rely on self-service appointment booking or receptionists calling out patients. These traditional approaches to scheduling appointments have several drawbacks. Given the unpredictability of medical consultations, doctors frequently fall behind in their schedule, which may cause patients to have to wait in the office past their scheduled appointment time. Furthermore, patient cancellations may cause inefficient scheduling when a doctor is unable to allocate another patient to an empty spot.

### BRIEF SUMMARY

Accordingly, it would be advantageous to provide improved mechanisms for scheduling appointments.

In an embodiment, a computer-implemented method reschedules medical appointments. The method comprises storing an appointment schedule information associated with a medical provider and receiving an indication that an appointment spot has become available. A patient is selected to fill the available spot based on an analysis of the appointment schedule information and patient data or doctor data. The method then transmits a notification of the available spot to the patient.

Method and computer program product embodiments are also disclosed.

Further embodiments, features, and advantages of the invention, as well as the structure and operation of the various embodiments, are described in detail below with reference to accompanying drawings.

### BRIEF DESCRIPTION OF THE DRAWINGS

The accompanying drawings, which are incorporated herein and form part of the specification, illustrate the present disclosure and, together with the description, further serve to explain the principles of the disclosure and to enable a person skilled in the relevant art to make and use the disclosure.

FIG. 1 is a diagram illustrating an example system for providing an automated waiting room queue and management service, according to an example embodiment.

FIG. 2 is a flowchart illustrating an example method of rescheduling appointments based on an algorithmic detection that an appointment may be delayed, according to an example embodiment.

FIG. 3 is a flowchart illustrating an example method of algorithmically filling an open appointment spot, according to an example embodiment.

FIG. 4 is a diagram illustrating an example computing device, according to an embodiment.

FIG. 5 is an illustration of a conventional medical record.

The drawing in which an element first appears is typically indicated by the leftmost digit or digits in the corresponding reference number. In the drawings, like reference numbers may indicate identical or functionally similar elements.

### DETAILED DESCRIPTION

Embodiments relate to a waiting room queue service that streamlines appointment service for medical practices by algorithmically determining appointment delays and open slots in the calendar. Open slots can then be filled by other patients to reduce vacancies in the practice schedule. Patients can also benefit from this service by having further opportunities to change their appointment time, yielding more flexibility in managing their personal schedule.

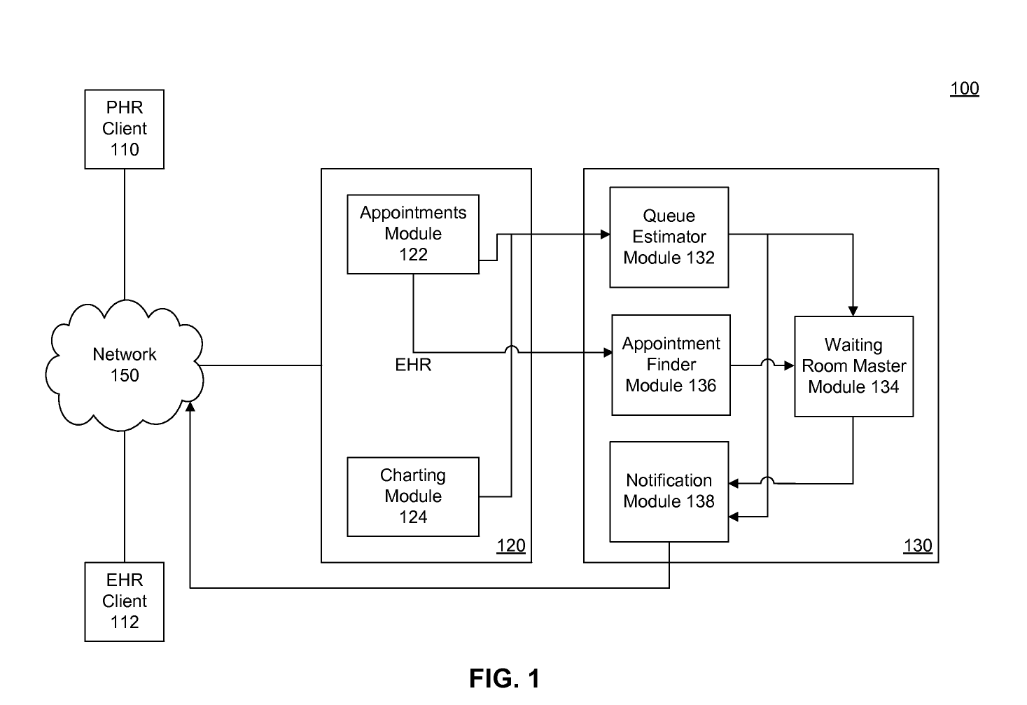

FIG. 1 is a diagram illustrating an example system 100 for providing an automated waiting room queue and management service, according to an example embodiment. System 100 includes a patient health record (PHR) client 110, an electronic health record (EHR) client 112, an EHR server 120, a waiting room queue service 130, and a network 150.

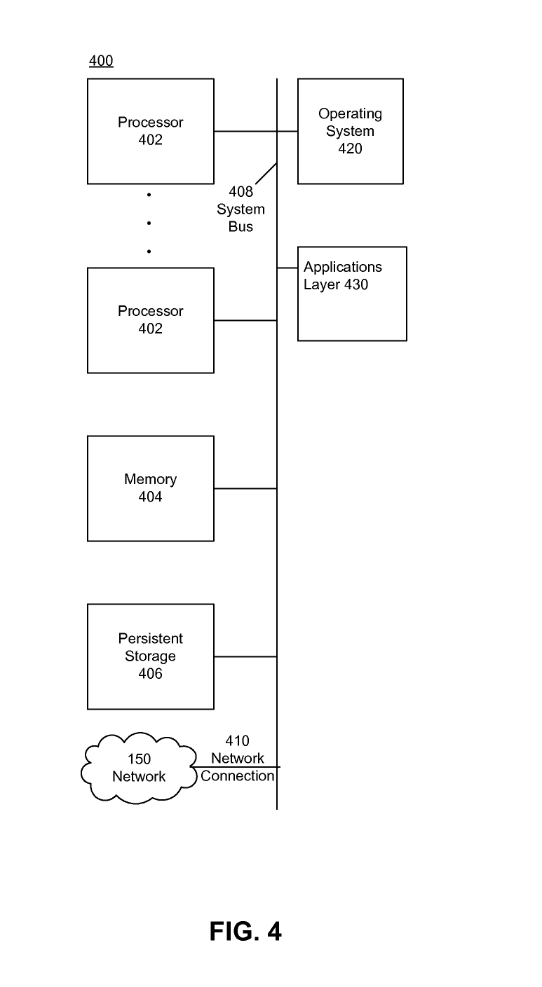

PHR client 110 may, for example, include a web browser that displays an interface to a PHR system. A PHR system is a patient portal component that provides patients an online means to communicate with EHR server 120 to view, download, and transmit their health information, and to review physician information and send and receive messages to and from physicians. The PHR system may, for example, be provided as an interface displayed on a web browser that enables a user to browse through the medical information and communicate with her doctor. In an embodiment, a PHR interface responds to user input, such as user selection of different portions of the interface, by sending an HTTP request to EHR server 120 via network 150. In another example, the PHR client 110 may include a native application instead of application running within a web browser. PHR client 110 may be any type of computing device, such as and without limitation, a PC, laptop, or mobile device. PHR client 110 may be a computing device as described below with reference to FIG. 4.

PHR client 110 may provide the ability for users to schedule medical appointments and receive notifications regarding their appointments. In an embodiment, PHR client 110 notifies patients if there is a delay in their appointment, and offers them the alternative of rescheduling for an earlier or later time.

EHR client 112 provides an interface into the EHR for medical providers. As with PHR client 110, EHR client 112 may include a web browser or a native application configured to provide a user interface to communicate with EHR system 120. The EHR interface allows doctors or medical practice staff to manage the practice, schedule appointments, access patient charts and medical history, and manage a waiting room queue. In an embodiment, EHR client 112 provides an interface for practice staff to enter the time that a patient is seen and the time her visit has ended, thus electronically keeping track of the waiting room queue.

EHR system 120 may be any computing device configured to provide an EHR system interface and functionality. EHR server 120 may be a computing device as described below with reference to FIG. 4. As previously described, EHR system 120 electronically stores a broad range of information about patients and medical practices, including health records and appointment schedules. PHR client 110 and EHR system 120 communicate through one or more networks 150, such as the Internet.

Waiting room queue service 130 is a component that evaluates information related to appointment schedules and patient charts to automatically manage a medical practice's waiting room. Queue service 130 may be part of EHR system 120, or may be on a separate module running on the same or a separate computing device.

EHR system 120 includes an appointments module 122 and a patient charting module 124. Appointments module 122 may maintain a calendar of patient appointments that have been scheduled. Patient charting module 124 may include information regarding patients who have a scheduled appointment, for example, information about their medical history, current medical conditions, medication history, test results, etc.

Waiting room queue service 130 includes a queue estimator module 132, a waiting room master module 134, an appointment finder module 136, and a notification module 138.

Queue estimator module 132 determines an estimated waiting time for a patient based information from EHR system 120. For example, queue estimator 132 may obtain charting information, historical patient appointment data, a manually entered waiting time estimate by a practice staff, etc. Historical patient appointment data may include, for example, information about the typical duration of appointments for the individual patient or individual doctor, the typical duration of appointments for the particular symptoms, condition or service, etc. Queue estimator 132 may obtain this information from EHR system 120. Based on this information, queue estimator 132 may determine an estimated waiting time for the patient. In an embodiment, queue estimator 132 calculates the waiting time by applying known statistical analysis to the historical waiting time information for patients in the practice, or similar practices, taking into account the conditions to be treated and procedures to be performed on each patient. In an embodiment, queue estimator 132 continuously, or at specified intervals, recomputes the estimated waiting times for patients as they are seen by a doctor, or as appointments are cancelled or rescheduled.

Waiting room master module 134 continuously, or at specified intervals, communicates with queue estimator 132 and determines whether to attempt to reschedule a medical appointment based on the estimated waiting times. Waiting room master module 134 may detect that a doctor is running behind schedule, and that one or more patient's appointments will be delayed. Upon determining that a patient's appointment will be delayed, waiting room master 134 determines whether to attempt to reschedule the patient's appointment. In making the determination to reschedule, waiting room master 134 may look at any information from EHR system 120, such as, for example, whether a patient has been responsive to notifications and willing to reschedule in the past, the urgency of the appointment's purpose, a patient preference for appointment time, the patient's home or work address, etc.

For example, the waiting room master 134 may determine the patient has previously been willing to reschedule in the past for later appointments, and based on this determination may attempt to reschedule the patient for a later time. If the patient has a history of not wanting to reschedule, then waiting room master 134 may try to reschedule patients around the patient to try to keep the scheduled time. In an embodiment, a patient may provide information regarding her preferred appointment times, and waiting room master 134 may attempt to reschedule for those times. In another example, waiting room master 134 takes into account how far the patient is travelling for the appointment, and may choose to reschedule patients that live or work closer to the medical practice. In another example, waiting room master 134 may determine that the patient is coming in for treatment of an urgent medical condition and therefore does not attempt to reschedule.

If waiting room master 134 determines that the practice should try to reschedule the appointment, it communicates with appointment finder 136 to find a potential new appointment spot for the patient and with notification module 138 to generate a notification for a patient.

Appointment finder module 136 can receive appointment information from appointments module 122 and determine a potential spot for a patient. Additionally, appointment finder module 136 may receive a notification from EHR server 120 when a patient cancels an appointment and thus an appointment spot becomes available. Appointment finder module 136 can then relay availability information to waiting room master module 134 to determine an appropriate spot for the patient. In an embodiment, appointment finder module 136 looks at appointment calendars of other medical practice that may treat the patient, such as other practices in the same medical specialty. Appointment finder module 136 may take into account the geographical proximity of the patient to various practices in determining potential appointment slots.

When waiting room master module 134 determines the need to reschedule, not only does it communicate with appointment finder module 136, it also communicates with notification module 138. In response to the communication, notification module 138 can generate a notification for a patient. Notification module 138 can then cause a notification to be sent to the client via PHR client 110. Again, in an embodiment, PHR client 110 can be a mobile device, and the user may receive a push notification regarding her appointment. For privacy, the push notification may also include a simple statement that a new message is available in the PHR client 110 interface. Then, the user may log into PHR client 110 interface to learn that the doctor is behind schedule. The message may offer the patient an alternate time and the opportunity for the patient to accept the new time or to wait under the currently delayed appointment time. The patient may then respond through the PHR client 110 interface. In this way, waiting room master module 134 can help reschedule when a doctor is running behind schedule.

Not only can waiting room master module 134 help reschedule when a doctor is running behind schedule, waiting room master 134 can also help reschedule when a patient cancels. In an embodiment, waiting room master 134 may receive information that a patient has cancelled an appointment and a new spot has become available. To avoid empty doctor time, waiting room master 134 may determine one or more patients that may be candidates for filling the spot, based on historical information obtained from EHR server 120, as previously explained. In choosing which patients to offer the spot, waiting room master 134 may look at any information from EHR system 120, such as, for example, whether a patient has been responsive to notifications and willing to reschedule in the past, the urgency of the appointment's purpose, a patient preference for appointment time, the patient's home or work address, etc. In an embodiment, waiting room master 134 may perform a probability analysis of patient information to determine which patients are most likely to benefit from rescheduling the appointment to the specified time. Waiting room master 134 then instructs notification module 138 to offer the spot to one or more selected patients. In an embodiment, the spot is taken by the first patient to accept the rescheduling offer.

In an embodiment, waiting room queue system 130 may charge a commission or subscription fee for its services, including referrals based on rescheduling. Doctors may benefit from this service because they may be able to fill in spots opened due to last minute cancellations.

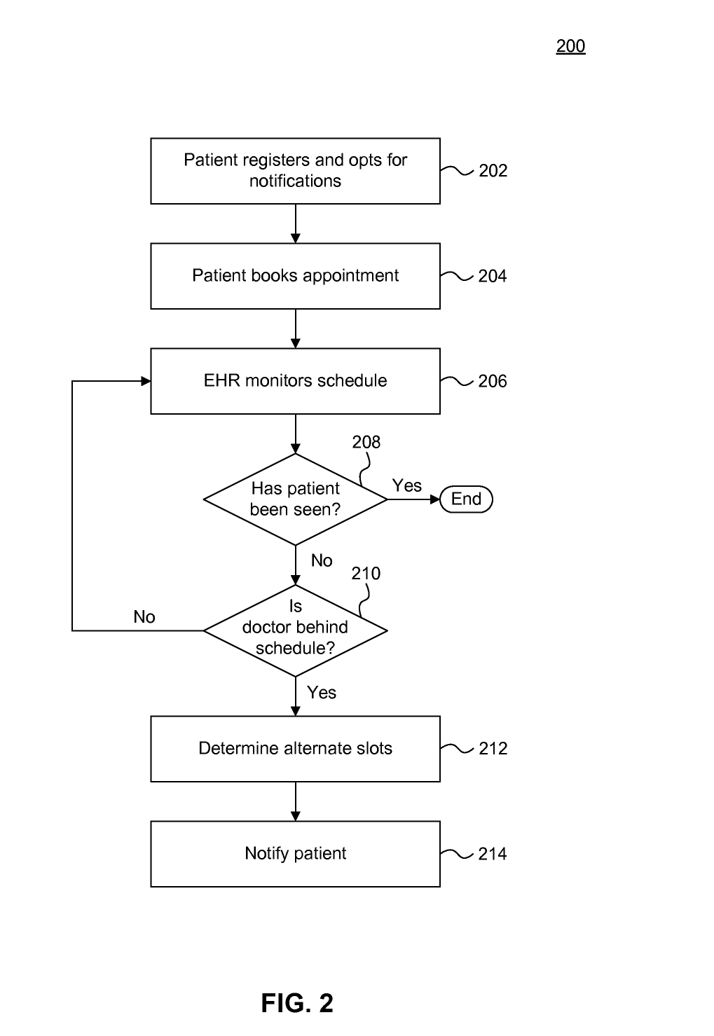

FIG. 2 is a flowchart of an example method 200 of rescheduling appointments based on an algorithmic detection that an appointment may be delayed, according to an example embodiment.

Method 200 begins at step 202. At step 202, a patient registers for online appointment management though a PHR system. Once registered, a patient can book appointments and opt for notifications of delays or newly available appointment slots in the practice or doctor's calendar. In an embodiment, a patient may also register to receive notifications of available spots at other medical practices. For example, if the patient has an appointment to see a particular urologist in a week, the patient may opt in to receive notifications of sooner appointment slots with another urologist.

At step 204, the patient books an appointment with a medical practitioner. In an embodiment, the patient books the appointment through the PHR interface. In another embodiment, the patient books the appointment directly with the practice by, for example, calling in and talking with the practice's frontdesk staff.

At step 206, an EHR system associated with the medical practice monitors the practice's appointment schedule and the waiting queue as patients arrive and get seen. As explained, the EHR system can obtain input from practice staff regarding when patients are taken in to be seen and can analyze any historical trends information to determine whether the doctor is running behind schedule.

As shown at step 208, if the patient has been seen, the process ends for that particular patient.

At step 210, if the patient has yet to be seen, the EHR system may detect that a doctor is running behind schedule and the patient's appointment may be delayed. The process would then move to step 212, where the EHR system would try to determine one or more alternate spots to suggest for the patient. For example, assume a patient schedules an appointment with Dr. Smith at 3 pm. At 1 pm, two hours before the scheduled appointment time, the EHR system determines Dr. Smith is running behind, but determines that Dr. Smith's colleague Dr. Bradford has an open slot at 3 pm, and Dr. Smith has an open slot the next day at 2 pm.

At step 214, the EHR system may transmit a notification to the patient alerting her that Dr. Smith is running behind, and offering one or more rescheduling options. Continuing the above example, the notification may offer the patient the opportunity to reschedule with Dr. Bradford at 3 pm, with Dr. Smith tomorrow at 9 am, or at the delayed time of 4 pm with Dr. Smith. In this manner, the patient can avoid having to wait at the doctor's office, and instead can reschedule for another time or doctor, or can choose to go to the appointment at the delayed time instead of waiting in the doctor's office.

In an embodiment, the notifications can be manually triggered or suggested by frontdesk practice staff. In another embodiment, the notifications are revised and approved by frontdesk practice staff.

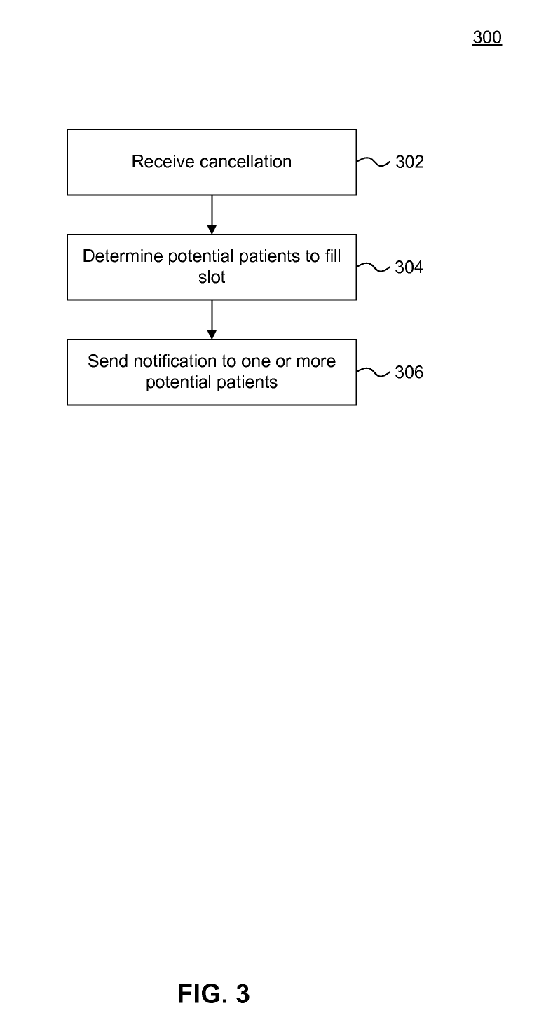

FIG. 3 is a flowchart of an example method 300 of algorithmically filling an open appointment spot, according to an example embodiment.

Method 300 begins at a step 302. At step 302, the EHR system detects that a patient has cancelled an existing appointment. The patient may have cancelled the appointment through the PHR interface, or by communicating the cancellation directly to the medical provider.

At step 304, the EHR system determines other patients that may be interested in rescheduling their appointments to the newly opened slot. For example, a patient named Jan may have signed up for patient alerts when signing up for an appointment with Dr. Wilson at 2 pm. The EHR associated with Dr. Wilson's office may then detect that a second patient has cancelled a 10 am appointment on the same day. Based on historical data of Jan's previous appointments and her profile preferences, the EHR system may determine that Jan prefers morning appointments, and thus lists Jan as a candidate for the newly open slot.

At step 306, the EHR system sends a notification to the other patients determined in step 304. Continuing the example, the EHR may send Jan and any other patients determined as candidates a notification alerting them of the newly opened spot. For example, the day before her appointment, Jan may be alerted that a new slot has opened at 10 am, and given the option to take the 10 am spot or keep her current 2 pm appointment.

### Comprehensive EHR System

A comprehensive EHR system includes a variety of components. Components of EHR systems vary from vendor to vendor and from setting to setting. For example, an EHR system in which embodiments of the present invention can be used may also include: (1) an electronic prescription (eRx) component, (2) a clinical and radiology laboratory component, (3) a transfer of care component, (4) a scheduling component, (5) a billing service component, and (6) patient portal component.

The electronic prescription component provides medical professionals capabilities to electronically generate and transmit prescriptions for patients' medications. Some EHR systems enable prescribers to view their patients' prescription benefit information at the point of care and select medications that are on formulary and covered by the patient's drug benefit. This informs physicians of potential lower cost alternatives (such as generic drugs) and reduces administrative burden of pharmacy staff and physicians related to benefit coverage.

The clinical and radiology laboratory component allows medical professionals to integrate with clinical laboratories to electronically receive and incorporate clinical laboratory tests and results into a patient's chart and create computerized provider order entry (“CPOE”) clinical laboratory orders. This component can also support functionality that enables medical professionals to electronically receive and incorporate radiology laboratory test results (e.g., x-ray, ultrasound, MRI, PET/CT scan, mammography) into a patient's chart.

Medical professionals can use the transfer of care component to transmit referrals electronically to other EHR users or to non-users by facsimile. Additionally, some EHR systems support electronically creating and transmitting consolidated continuity of care documents.

The scheduling component offers functionality that allows healthcare providers to manage their appointments with an electronic schedule that can be integrated into a practice's workflow.

The billing service component offers medical professionals the ability to electronically generate and transmit superbills. Superbills are the data source for the creation of a healthcare claim. The billing service component can transmit superbills to medical billing software accounts controlled by the professionals' offices or their billing service providers. This component also allows a healthcare professional to save a superbill and transmit it to the health care professional's billing account with the billing software vendor.

The patient portal component allows medical professionals to grant their patients an online means to view, download, and transmit their health information, often called the personal health record (PHR). This component also provides patients with the ability to review their physicians and send and receive secure messages directly to and from their physicians.

Together, these components leverage the benefits of EHRs while mitigating the risks.

### Example Computing Device

Each of the servers and modules in FIG. 1 may be implemented on the same or different computing devices in hardware, software, or any combination thereof. Such computing devices can include, but are not limited to, a personal computer, a mobile device such as a mobile phone, workstation, embedded system, game console, television, set-top box, or any other computing device. Further, a computing device can include, but is not limited to, a device having a processor and memory, including a nontransitory memory, for executing and storing instructions. The memory may tangibly embody the data and program instructions. Software may include one or more applications and an operating system. Hardware can include, but is not limited to, a processor, memory, and graphical user interface display. The computing device may also have multiple processors and multiple shared or separate memory components. For example, the computing device may be a part of or the entirety of a clustered computing environment or server farm.

An example computing device is illustrated in FIG. 4. FIG. 4 is a diagram illustrating a computing device 400 that accesses a network 150 over a network connection 410 that provides computing device 400 with telecommunications capabilities. Computing device 400 uses an operating system 420 as software that manages hardware resources and coordinates the interface between hardware and software.

In an embodiment, computing device 400 contains a combination of hardware, software, and firmware constituent parts that allow it to run an applications layer 430. Computing device 400, in embodiments, may be organized around a system bus 408, but any type of infrastructure that allows the hardware infrastructure elements of computing device 400 to communicate with and interact with each other may also be used.

Processing tasks in the embodiment of FIG. 4 are carried out by one or more processors 402. However, it should be noted that various types of processing technology may be used here, including multi-core processors, multiple processors, or distributed processors. Additional specialized processing resources such as graphics, multimedia, or mathematical processing capabilities may also be used to aid in certain processing tasks. These processing resources may be hardware, software, or an appropriate combination thereof. For example, one or more of processors 402 may be a graphics-processing unit (GPU). In an embodiment, a GPU is a processor that is a specialized electronic circuit designed to rapidly process mathematically intensive applications on electronic devices. The GPU may have a highly parallel structure that is efficient for parallel processing of large blocks of data, such as mathematically intensive data common to computer graphics applications, images and videos.

In order to manipulate data in accordance with embodiments describe herein, processors 402 access a memory 404 via system bus 408. Memory 404 is nontransitory memory, such as random access memory (RAM). Memory 404 may include one or more levels of cache. Memory 404 has stored therein control logic (i.e., computer software) and/or data. For data that needs to be stored more permanently, processors 402 access persistent storage 406 via system bus 408. Persistent storage 406 may include, for example, a hard disk drive and/or a removable storage device or drive. A removable storage drive may be an optical storage device, a compact disc drive, flash memory, a floppy disk drive, a magnetic tape drive, tape backup device, and/or any other storage device/drive.

Processors 402, memory 404, and persistent storage 406 cooperate with operating system 420 to provide basic functionality for computing device 400. Operating system 420 provides support functionality for applications layer 430.

Network connection 410 enables computer device 400 to communicate and interact with any combination of remote devices, remote networks, remote entities, etc. For example, network connection 410 may allow computer device 400 to communicate with remote devices over network 150, which may be a wired and/or wireless network, and which may include any combination of LANs, WANs, the Internet, etc. Control logic and/or data may be transmitted to and from computer device 400 via network connection 410.

Applications layer 430 may house various modules and components. For example, EHR system 120, appointment module 122, patient charting module 124, waiting room queue service 130, queue estimator module 132, waiting room master module 134, appointment finder module 136, and notification module 138 may be included in applications layer 430 when computing device 400 is used as EHR system 120.

It should be noted that computer-readable medium embodiments may include any physical medium which is capable of encoding instructions that may subsequently by used by a processor to implement methods described herein. Example physical media may include floppy discs, optical discs (e.g. CDs, mini-CDs, DVDs, HD-DVD, Blu-ray), hard drives, punch cards, tape drives, flash memory, or memory chips. However, any other type of tangible, persistent storage that can serve in the role of providing instructions to a processor may be used to store the instructions in these embodiments.

### Comprehensive EHR System

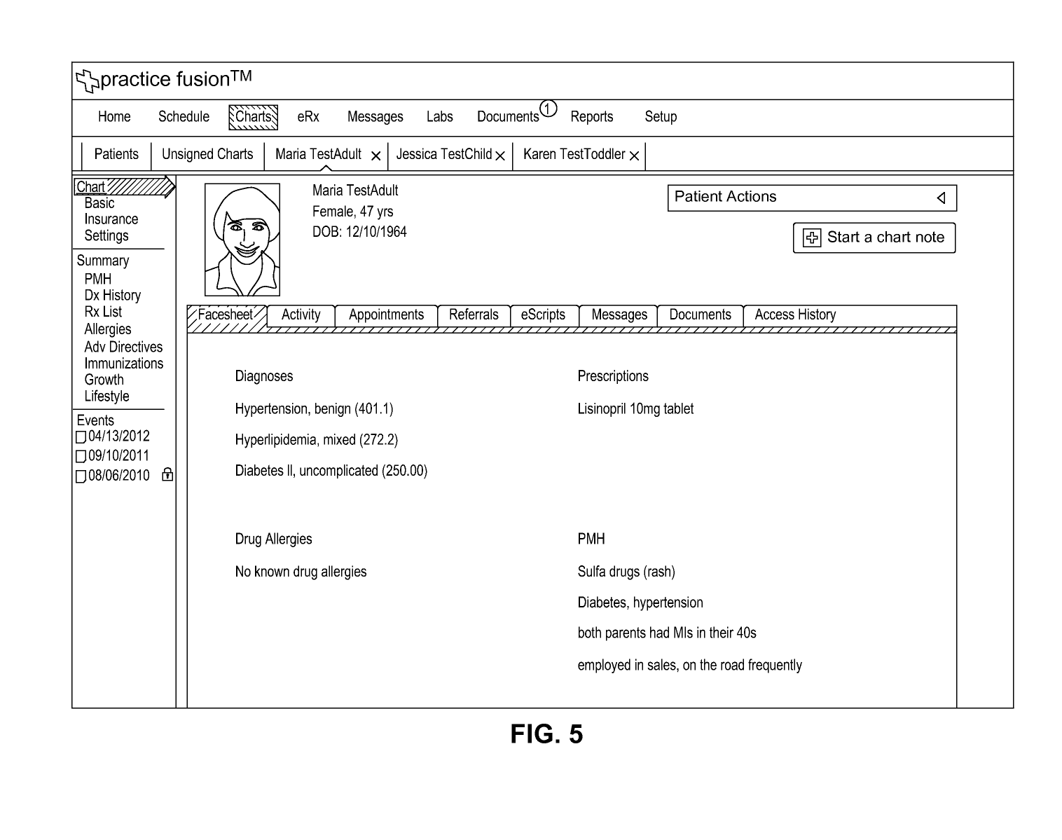

FIG. 5 is an illustration of a conventional medical record. A comprehensive EHR system includes a variety of components. Components of EHR systems vary from vendor to vendor and from setting to setting. For example, an EHR system in which embodiments of the present invention can be used may also include: (1) an electronic prescription (eRx) component, (2) a clinical and radiology laboratory component, (3) a transfer of care component, (4) a scheduling component, (5) a billing service component, and (6) patient portal component.

The electronic prescription component provides medical professionals capabilities to electronically generate and transmit prescriptions for patients' medications. Some EHR systems enable prescribers to view their patients' prescription benefit information at the point of care and select medications that are on formulary and covered by the patient's drug benefit. This informs physicians of potential lower cost alternatives (such as generic drugs) and reduces administrative burden of pharmacy staff and physicians related to benefit coverage.

The clinical and radiology laboratory component allows medical professionals to integrate with clinical laboratories to electronically receive and incorporate clinical laboratory tests and results into a patient's chart and create computerized provider order entry (“CPOE”) clinical laboratory orders. This component can also support functionality that enables medical professionals to electronically receive and incorporate radiology laboratory test results (e.g., x-ray, ultrasound, MRI, PET/CT scan, mammography) into a patient's chart.

Medical professionals can use the transfer of care component to transmit referrals electronically to other EHR users or to non-users by facsimile. Additionally, some EHR systems support electronically creating and transmitting consolidated continuity of care documents.

The scheduling component offers functionality that allows healthcare providers to manage their appointments with an electronic schedule that can be integrated into a practice's workflow.

The billing service component offers medical professionals the ability to electronically generate and transmit superbills. Superbills are the data source for the creation of a healthcare claim. The billing service component can transmit superbills to medical billing software accounts controlled by the professionals' offices or their billing service providers. This component also allows a healthcare professional to save a superbill and transmit it to the health care professional's billing account with the billing software vendor.

The patient portal component allows medical professionals to grant their patients an online means to view, download, and transmit their health information, often called the personal health record (PHR). This component also provides patients with the ability to review their physicians and send and receive secure messages directly to and from their physicians.

Together, these components leverage the benefits of EHRs while mitigating the risks.

### CONCLUSION

Identifiers, such as “(a),” “(b),” “(i),” “(ii),” etc., are sometimes used for different elements or steps. These identifiers are used for clarity and do not necessarily designate an order for the elements or steps.

Embodiments of the present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A computer-implemented method of rescheduling medical appointments comprising:
storing, by at least one computing device, an appointment schedule information associated with a medical provider;
receiving, by the at least one computing device, an indication that an appointment spot has become available; and
selecting, by the at least one computing device, a patient to fill the available spot based on an analysis of the appointment schedule information and at least one of a patient data and a doctor data; and
transmitting, by the at least one computing device, a notification of the available spot to the patient.

2. The method of claim 1, wherein the analysis of patient data comprises analyzing at least one of a history of patient appointments, a history of patient responsiveness to notifications, an address associated with the patient and a medical history of the patient.

3. The method of claim 1, wherein the analysis of doctor data comprises analyzing at least one of a history of appointment durations, a purpose of the appointment, a type of medical practice.

4. The method of claim 1, wherein the doctor data is associated with a plurality of providers.

5. The method of claim 1, wherein the transmitting comprises transmitting the notification of the available spot to a plurality of patients.

6. The method of claim 5, further comprising:
receiving a response from at least one of the plurality of patients; and
scheduling the available spot to the at least one of the plurality of patients.

7. A computer-implemented method of rescheduling medical appointments comprising:
storing, by at least one computing device, an appointment schedule information associated with a medical provider;
receiving, by the at least one computing device, an indication that the medical provider is running behind the appointment schedule; and
determining, by the at least one computing device, one or more alternate appointment times based on an analysis of the appointment schedule information and at least one of a patient data and a doctor data; and
transmitting, by the at least one computing device, a notification of the one or more alternate appointment times to the patient.

8. The method of claim 7, wherein the determining the medical provider is running behind the appointment schedule is based on an analysis of the appointment schedule information and at least one of a patient data and a doctor data.

9. The method of claim 8, wherein the analysis of doctor data comprises analyzing at least one of a history of appointment durations, a purpose of the appointment, a type of medical practice.

10. A system for rescheduling medical appointments comprising:
one or more computing devices;
an appointments module, implemented in the one or more computing devices, that stores an appointment schedule information associated with a medical provider; and
a waiting room queue module, implemented in the one or more computing devices, that:
receives an indication that an appointment spot has become available; and
selects a patient to fill the available spot based on an analysis of the appointment schedule information and at least one of a patient data and a doctor data; and
transmits a notification of the available spot to the patient.

11. The system of claim 10, wherein the analysis of patient data comprises analyzing at least one of a history of patient appointments, a history of patient responsiveness to notifications, an address associated with the patient and a medical history of the patient.

12. The system of claim 10, wherein the analysis of doctor data comprises analyzing at least one of a history of appointment durations, a purpose of the appointment, a type of medical practice.

13. The system of claim 10, wherein the doctor data is associated with a plurality of providers.

14. The system of claim 10, wherein the transmitting comprises transmitting the notification of the available spot to a plurality of patients.

15. The system of claim 14, wherein the waiting room queue module further:
receives a response from at least one of the plurality of patients; and
schedules the available spot to the at least one of the plurality of patients.

16. A program storage device tangibly embodying a program of instructions executable by at least one machine to perform a method for presenting medical data, the method comprising:
storing an appointment schedule information associated with a medical provider;
receiving an indication that an appointment spot has become available; and
selecting a patient to fill the available spot based on an analysis of the appointment schedule information and at least one of a patient data and a doctor data; and
transmitting a notification of the available spot to the patient.

17. The program storage device of claim 16, wherein the analysis of patient data comprises analyzing at least one of a history of patient appointments, a history of patient responsiveness to notifications, an address associated with the patient and a medical history of the patient.

18. The program storage device of claim 16, wherein the analysis of doctor data comprises analyzing at least one of a history of appointment durations, a purpose of the appointment, a type of medical practice.

19. The program storage device of claim 16, wherein the doctor data is associated with a plurality of providers.

20. The program storage device of claim 16, wherein the transmitting comprises transmitting the notification of the available spot to a plurality of patients.
